(19) United States
(12) Patent Application Publication
(10) Pub. No.: US 2007/0193061 A1
(43) Pub. Date: Aug. 23, 2007

(54) Building and Construction Materials and Method of Manufacturing the Same

(75) Inventor: Jeong-min Sul, Busan (KR)

Correspondence Address: ADELI LAW GROUP, A PROFESSIONAL LAW CORPORATION, 1875 CENTURY PARK EAST, SUITE 1360, LOS ANGELES, CA, 90067, US

(73) Assignees: Byung-euk MIN, Ulsan-city (KR); Byung-soo SEO, Ulsan-city (KR); ILTER of HAPPY PEOPLE CO., LTD., Ulsan-city (KR)

(21) Appl. No.: 11/678,060

(22) Filed: Feb. 22, 2007

(30) Foreign Application Priority Data
Feb. 23, 2006 (KR) 10-2006-0017790

(51) Int. Cl. F26B 7/00

(52) U.S. Cl. 34/382; 34/386

(57) ABSTRACT

Provided are building and construction materials and a method of manufacturing the same. The method includes: creating a mixture by mixing clay ripened and aged in a supplier with ash and water; removing foreign materials such as stones from the mixture using a selector; removing air from the mixture using a vacuum pug mill; molding the mixture by injecting the mixture from which the air is completely removed into a prescribed mold and pressing the mixture with a press; drying a product molded in the molding step; and calcinating the dried product in a kiln. Thus, ash generated in a thermal power plant and buried is used as an alternative aggregate to a scantily available natural aggregate, thereby solving environmental problems due to the burying of waste.

### BACKGROUND OF THE INVENTION

1. Field of the Invention

The present invention relates to building and construction materials obtained from ash, i.e., general wastes from a thermal power plant and a method of manufacturing the same, and more particularly, to building and construction materials and a method of manufacturing the same, in which fly ash or bottom ash that has been dumped and buried in the vicinity of a power plant is employed for an environmentally-friendly material, resistant to seawater, and resistant to penetration, etc.

2. Description of the Related Art

In general, ash from coal is a residue that remains after incineration or combustion. Most ash is generated in a thermal power plant, but some ash is also generated in a waste incinerator, a combined-heat power plant and other industrial fields. The ash is recyclable because it is the residue of the combustion, i.e., it is an inorganic substance (for example, SiO₂, Al₂O₃, and Fe₂O₃). However, the ash additionally contains unburnt carbon during the combustion, so that a problem arises in technical applications.

The ash is largely classified into two types according to the size of a particle. The particles smaller than 100 μm are regarded as fly ash (it flies), and the others are regarded as bottom ash (it falls).

Further, the coal used in the waste incinerator, the combined-heat power plant and other industrial fields is classified into hard coal and soft coal according to degrees of carbonization. Hard coal contains 90˜95% carbon, and soft coal contains less carbon than hard coal. Peat, lignite and brown coals belong to soft coal, in which the peat contains 60% carbon, the lignite and brown coals contain 70% carbon, and a bituminous coal contains 80˜90% carbon. In the case of hard coal, about 30˜50% of raw coal remains as ash. In the case of soft coal, about 10˜15% of raw coal remains as ash. Such a residue percentage of ash varies according to coal quality. Thus, combustion efficiency of soft coal is higher than that of hard coal.

While burning coal, an organic substance burns as fuel but the inorganic substance remains as ash. In the state that the ash scatters in a chimney of a boiler, heavy ash falls to the bottom of the boiler but light ash is collected by an electric collector from the chimney. Here, the heavy ash that falls to the bottom will be called “bottom ash”, and the light ash that flies up and is collected by the collector will be called “fly ash.”

Most ash is collected by the collector or on the bottom of the boiler, and the amount of collected ash is 15˜45% of the total pulverized coal. Generally, about 60˜80% of the total ash is the fly ash collected in the collector, and the other 20˜40% is the bottom ash collected on the bottom of the boiler.

The bottom ash attaches to a wall, a preheater, a cutter, etc. of the boiler, falls to the bottom of the boiler under its own weight or by a load variation dust remover, etc., gets collected in a hopper, and is milled by a mill.

In general, the hopper for the bottom ash is filled with 60° C. water. This water breaks up the high temperature bottom ash (more than 760° C.) by thermal shock, prevents the collected bottom ash from being fused and bonded to the heated hopper, and reduces frictional resistance between the bottom ash and a wall of the hopper while discharging the bottom ash.

Meanwhile, a direct sluicing system, a storing system in a dewatering bin, a water recirculation system, a chain conveyer system, etc., are known as a bottom ash system.

The direct sluicing system directly transports the bottom ash, discharged from the hopper in a lower part of the boiler, together with water, to an ash treatment plant via an ash transport pipe. An ash treatment process includes milling the bottom ash in a clinker state, mixed with water, with the mill provided in an outlet of the hopper, and transporting the milled ash to the ash treatment plant using a jet pump. The direct sluicing system is very advantageous in a case where a distance from the power plant to the ash treatment plant is relatively short, and generally employs seawater because a lot of water is required for the ash treatment. Further, to take a countermeasure against water pollution due to water used in the ash treatment, and to reduce the amount of used water, the direct sluicing system employs a method of recycling the water used in the ash treatment to the bottom ash hopper.

The storing system in the dewatering bin transports the milled bottom ash together with water to the dewatering bin via the ash transport pipe, stores the bottom ash for twenty four hours or more to dewater the same, carries the dewatered bottom ash through a belt conveyer, a truck or the like, and buries the bottom ash in the ash treatment plant, or utilizes it for other purposes. The storing system in the dewatering bin can be adapted to a case where the bottom ash is utilized for roadbed material, cement raw material, etc.

The water recirculation system dewaters the bottom ash mixed with water after transporting it to the dewatering bin, similar to the storing system in the dewatering bin, but in contrast, transports water discharged from the dewatering bin to a precipitation pond or tank to thereby precipitate it out to recirculate it. The water recirculation system is mainly applicable to a large-scale coal thermal power plant because the amount of water required for the ash treatment is minimized.

Further, in the chain conveyer system, a soaking chain conveyer is provided in a clinker hopper on the bottom of the boiler, so that the bottom ash fallen to the bottom of the boiler is rapidly cooled and broken up by water in the hopper and discharged outside the hopper along the conveyer. Advantageously, the chain conveyer system requires less motive power, occupies a smaller space, and uses a smaller amount of water in the ash treatment, so that it has been widely used in Europe, such as in Germany.

Below, basic chemical and physical properties of the bottom ash will be described.

The bottom ash has a dark gray and uneven grain, and its surface is porous. In other words, the bottom ash looks like sand and includes irregularly shaped grains having a diameter of 5 mm or more. Further, main chemical components of the bottom ash include SiO₂, Al₂O₃, Fe₂O₃, CaO, MgO, Na₂O and K₂O. Among them, the composition percentage of SiO₂, Al₂O₃ and Fe₂O₃ in the bottom ash is 70.0˜45.4%, 28.3˜15.9%, and 14.3˜2.0%, respectively. Thus, SiO₂, Al₂O₃ and Fe₂O₃ occupy a large volume of the bottom ash in sequence.

The bottom ash does not contain as much glass paste as the fly ash or blast furnace slag has, but contains enough glass paste to have an effect on long-term strength.

As for the physical properties of the bottom ash, the bottom ash generally has a gray color, but also may have various colors such as dark yellow, black, gray-white, etc. according to different generation environments. The unburnt carbon shows black, and silica and alumina show gray-white and yellow. The bottom ash is not suitable to be used as a binding material because of its shape, chemical compositions, etc. Further, the bottom ash has a specific gravity of 2.1˜2.7, and a dry weight of 720˜1600 kg/m³. Also, the bottom ash has no plasticity, and its absorptivity has a broad range of about 2.0˜10.0%.

Meanwhile, the amount of ash generated varies according to coal quality. For example, hard coal generates about 30-40% ash, in which fly ash is about 60-80% and bottom ash is about 20-40%. On the other hand, soft coal does not generate as much ash as hard coal generates because soft coal has higher combustion efficiency than hard coal. Mostly, soft coal generates about 10-20% of the raw coal as ash, in which a ratio of fly ash and bottom ash is about 7:3.

The foregoing bottom ash has recently been researched in various fields at home and abroad, for example, artificial ground construction using ash from coal, high quality fertilizer production using ash from coal, cuttlefish wastes and sawdust, road concrete development using bottom ash, water treatment agent development using ash from high carbon coal, agricultural uses of coal ash, etc.

Examples of using bottom ash as an aggregate include natural and artificial aggregates partially substituted with bottom ash (refer to Korean Patent First Publication No. 1997-074076), bottom ash from a combined-heat power plant employed in manufacturing a light building material (refer to Korean Patent First Publication No. 1997-061815), and bottom ash used as an aggregate for a concrete article (refer to Korean Patent First Publication No. 2002-0026794), and so on.

According to the present invention, the ash generated as a byproduct in the foregoing coal thermal power plant can be utilized as an aggregate, e.g., as a substitute for the aggregate in constructing seashore facilities, and can be applied to a fishing reef.

The fishing reef may be artificially constructed in the ocean and used as a fishery facility to collect, protect and cultivate certain aquatic products. On the basis of the nature that marine life such as fish gather around a shore reef or a sunken ship, this fishery facility may be used to increase fishery products and protect marine life from overfishing.

Work on artificial fishing reefs, in which enormous expenditure has been invested, has been ongoing since 1971 in order to improve a difficult fishery environment and to conserve nature against unlawful trawl fishery, as shown in the following Table 1. A decade ago, a hemispherical reef shaped like a gourd was installed on a coast where the sea had a depth of less than 20 m, and a rectangular reef having a cross distance of 2 m was installed on the coast where the sea had a depth of more than 30 m. In the early days, the fishing reefs were randomly placed in an area, and they did not fulfill their duties due to heavy loss. Accordingly, the fishing reefs have recently stacked in a block formation.

TABLE 1
Domestic Report on Artificial Fishing Reef Facilities

| | | 1972˜1980 | 1981˜1985 | 1986˜1990 | 1991˜2000 | 2001 | Total |
|---|---|---|---|---|---|---|---|
| Area(ha) | | 214 | 1,533 | 4,853 | 13,854 | 709 | 21,163 |
| Sort | Rectangular | 5,041 | 12,327 | 15,655 | 57,662 | 1,641 | 92,299 |
| | reef | | | | | | |
| | Circular reef | — | 313 | 1,979 | — | — | 2,292 |
| | Hemispherical | — | 328 | 11,548 | 9,385 | — | 21,261 |
| | reef | | | | | | |
| | Old ship reef | — | 21 ships | — | — | 4 ships | 25 ships |
| | Bungalow reef | — | — | — | 1440 | 1,376 | 2,816 |
| | Jumbo reef | — | — | 79 | — | — | 79 |
| | Triangular | — | — | 100 | 60,121 | 2,603 | 62,824 |
| | Pyramid reef | | | | | | |
| | Overbridge | — | — | 700 | 4,540 | — | 5,240 |
| | reef | | | | | | |
| | Steel reef | — | | — | — | 11 | 11 |
| | Test reef | — | — | — | — | — | — |
| | Sea jungle | — | — | — | — | 120 | 120 |

| | | | | | | |
|---|---|---|---|---|---|---|
| Expense | 131 | 1,821 | 6,593 | 68,761 | 5,527 | 82,833 |
| (million won) | | | | | | |

In the meantime, not only fishing reefs but also various reefs such as an ear shell reef, a seaweed reef, etc., have recently been manufactured at enormous expense, according to local and ecological characteristics, so as to enhance the effect of the reefs.

The reef functions like a wall against an ocean current and causes whirlpools, so that microbial foods and organic substances are mixed with each other, thereby providing fish and other organisms with abundant food. Also, the reef allays the effect of the ocean currents and thus provides the fish with a hiding or spawn place.

The artificial reef may be manufactured on land and moved into the sea. Further, the artificial reef may be placed on an unstable sea floor, therefore a loss of function due to being buried should be properly considered. To prevent the effect artificial reef from being reduced, it should be lightweight, environmentally-friendly, and resistant to seawater. Accordingly, the present invention utilizes the ash in sufficient consideration of these points.

However, the artificial reef has such a large specific gravity that it drops rapidly when placed into the sea and sunk to the sea floor. Therefore, the artificial reef may be damaged when it comes to the bottom. On the other hand, the artificial reef may be buried when placed on a soft sea floor, thereby losing the inherent function thereof.

Further, the conventional artificial reef is quickly corroded by seawater as it contains calcium hydroxide or the like, thereby deteriorating the durability thereof. Additionally, a strongly alkaline noxious substance, such as precipitation and dissolution substances due to corrosion, can damage the environment.

In particular, the reef may be installed on the soft floor of the deep sea as necessary, and thus the weight of the reef should be small relative to its internal volume so as to prevent burying and to facilitate transportation and installation.

Chloride ions may be a noxious substance contained in seawater. If the chloride ions penetrate the concrete, the chloride ions break a passive film stably protecting the iron reinforcing rod, so that the iron reinforcing rod is likely to corrode. When the iron reinforcing rod is corroded inside the concrete, a cross-section of the iron reinforcing rod is damaged, thereby not only reducing the strength of the whole structure but also expanding the volume of the iron reinforcing rod by 2.5 times. Such expansion pressure causes the iron reinforcing rod to crack.

Meanwhile, cement, stone, granite, etc. are generally mixed for the building and construction materials, but there are problems in that a treatment process is difficult and a noxious component of the cement remains, so that they are not suitable for the building and construction materials. Also, there is no skill to produce even the existing product structure.

Accordingly, the present inventor has pursued broad research into strength and durability while varying a mixed ratio of the ash as an alternative to the aggregate, and the research resulted in a reef that has approximately the same strength and durability as that using only a natural aggregate including sand and detritus, and has excellent resistance to sulfate and permeability as compared with that using only the natural aggregate.

### SUMMARY OF THE INVENTION

The present invention provides building and construction materials and a method of manufacturing the same, in which ash having a smaller unit-weight than a natural aggregate is used so that the building and construction materials are not as likely to come down too rapidly or be buried, as compared with the existing structure, even if they are installed on a soft sea floor.

The present invention also provides building and construction materials and a method of manufacturing the same, in which ash is used for a combination aggregate to effectively deal with lack of the building and construction materials as a natural aggregate is exhausted.

The present invention also provides building and construction materials and a method of manufacturing the same, in which ash is used, i.e., waste resources are utilized for helping environmental conservation.

According to an aspect of the present invention, there is provided a method of manufacturing building and construction materials including: creating a mixture by mixing clay ripened and aged in a supplier with ash and water; removing foreign materials such as stones from the mixture using a selector; removing air from the mixture using a vacuum pug mill; molding the mixture by injecting the mixture from which the air is completely removed into a prescribed mold and pressing the mixture with a press; drying a product molded in the molding step; and calcinating the dried product in a kiln.

The calcination step may be performed in a kiln heated at 1000˜1300° C. for 24˜30 hours.

The drying step may include a primary drying step in shade for 1˜3 days, primarily to remove moisture, and a secondary drying step after the primary drying step, in sunlight, to secondarily remove any remaining moisture.

The mixture may be created by mixing the ripened and aged clay and the ash in a ratio of 50% to 40˜50%.

The ash may include fly ash or bottom ash.

The clay may be ripened and aged for one year.

The calcination step may include adjusting colors of the building and construction materials through a cooling process.

The method may further include checking whether the mixture contains air after removing the.

According to another aspect of the present invention, there is provided building and construction materials manufactured by the foregoing method.

The building and construction materials may include one of a tile, a brick, a block, an interlocking, an artificial reef, a curb, a hume pipe, a revetment block and a vegetation block.

### BRIEF DESCRIPTION OF THE DRAWINGS

The above and other features of the present invention will be described in reference to certain exemplary embodiments thereof with reference to the attached drawings in which:

FIG. 1 is a flowchart for explaining a method of manufacturing building and construction materials according to an exemplary embodiment of the present invention;

FIG. 2 illustrates a stacked state of fishing reefs as a marine construction formed by the manufacturing processes of FIG. 1;

FIG. 3 is a graph of temperature variation with respect to time for calcinating a fishing reef in a kiln; and

FIG. 4 is a graph of temperature variation with respect to time for calcinating a construction material such as a brick, a tile or the like in a kiln.

### DETAILED DESCRIPTION OF THE INVENTION

Hereinafter, preferred embodiments of the present invention will be described with reference to the accompanying drawings.

First, a yellow soil (i.e., clay) will be described.

Table 2 shows a component analysis of soil used in an exemplary embodiment of the present invention (refer to state-certified test results).

According to an exemplary embodiment of the present invention, clay (yellow soil) and ash, which undergo the component analysis based on this scientific data, are precisely mixed to manufacture building and construction materials, thereby an environmentally-friendly clay (yellow soil) product for building and construction being produced.

TABLE 2
Component Analysis of Soil to be used in the Present
Invention (refer to State-Certified Test results)

| | | | | | | | | ig. | |
|---|---|---|---|---|---|---|---|---|---|
| | SiO₂(%) | Fe₂O₃(%) | Al₂O₃(%) | CaO(%) | MgO(%) | K₂O(%) | Na₂O(%) | loss | remarks |
| Clay | 61.6 | 5.93 | 17.0 | 0.43 | 1.18 | 1.90 | 0.53 | 5.0 | |

According to an exemplary embodiment of the present invention, only various kinds of special soil which can be found in various places in Korea are precisely mixed, and the mixture is calcinated to form a product having functions of building and construction materials. The product contains no toxicity, but has semi-permanent strength and provides a human body with abundant and beneficial far-infrared ray.

Thus, the product according to an exemplary embodiment of the present invention is superior to other product in the functions of the building and construction materials, and radiates a lot of far-infrared ray to help preserving environment by relieving the environment.

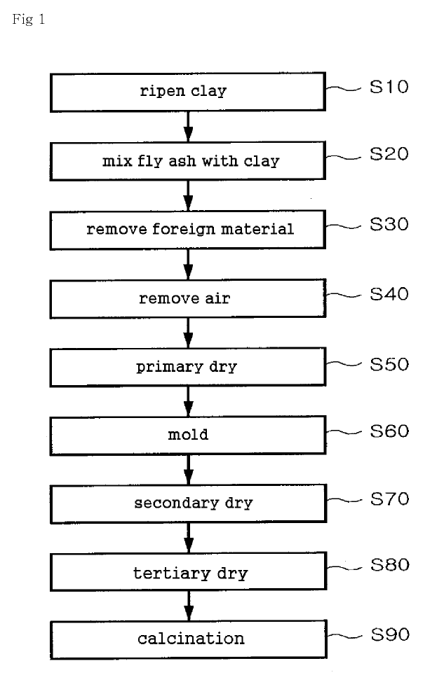

Below, an exemplary embodiment of the present invention will be described with reference to FIG. 1.

FIG. 1 is a flowchart for explaining a method of manufacturing building and construction materials according to an exemplary embodiment of the present invention.

First, mass clay is naturally ripened and aged with snow and rain for one year by the same method of making compost (S10).

In a supplier, the ripened and aged clay is mixed with ash (fly ash or bottom ash) in a ratio of 40˜50%:50% while containing water of 18% (S20). That is, the amount of water is adjusted to be of 18% of the total mixture of the ash, the clay and water.

Next, foreign materials such as stone, roots, glass pieces, etc. are removed from the mixture in the supplier by a selector (S30).

The mixture in which the foreign materials have been removed in step S30 is put into a primary roller and a secondary roller.

Then, air is perfectly removed from the mixture, passed through the secondary roller, by a vacuum pug mill and a screw filter or the like (S40). That is, the air is removed from the mixture by rotation of a screw mounted in the vacuum pug mill.

The vacuumed mixture in step S40 is passed through the mold attached to an inlet of a primary vacuum pug mill, thereby producing a molded material.

Thereafter, it is precisely checked as to whether the product passed through the vacuum pug mill has been sufficiently vacuumed or not. For example, this check can be performed by cutting the vacuumed clay with a string wire. If the cross-section of the cut clay includes no bubbles and no holes, the mixing and vacuuming steps are decided to be successful.

Then, the perfectly vacuumed product is primarily dried in a shade for three days (S50). While drying the product, the product should not get twisted and cracked. Further, the product should be well dried. That is, the product should have no moisture.

The material completely dried in step S50 is molded in a molding machine (press) (S60).

The product molded in step S60 is secondarily dried (S70). In particular, the product is dried in the shade for three days. At this time, the product should not receive any impact such as wind or the like. If the product receives an impact, it may be twisted or cracked.

The product dried for three days in step S70 is tertiary dried in sunlight by 100% for four days (S80). In this step, the product is turned upside down to face the sunlight so as to completely dry the front, rear, left and right of the product.

Then, the perfectly dried products from step S80 are stacked in a kiln. Here, the products are supported by a support member so that the products maintain prescribed intervals to receive uniform flames and do not fall down.

When the products are all stacked in the kiln, a door of the kiln is closed slowly.

Then, the products are calcinated while increasing a temperature from 0° C. to 1200˜1300° C. with two burners of both sides (S90).

In step S90, the moisture is completely removed from the product while increasing the temperature up to 600° C., and then the temperature may be slowly increased further.

If the temperature ranges from 100° C. to 1100° C. while calcinating all products stacked in the kiln, the color, the strength and the absorptivity of the product become good. Further, a noxious substance is changed into an innoxious substance. According to an exemplary embodiment of the present invention, the calcinating temperature is adjusted to determine the color of the molded product.

The foregoing temperature adjustment allows the product to have a proper strength, a proper absorptivity, no twisting and no cracks, so that it can pass Korean Standard (KS) (refer to the test results).

With this method, the building and construction materials contain no noxious adhesive additives.

That is, if the clay contains the noxious adhesive additives, it is impossible to ripen and mold the product.

Further, if the vacuum process of the vacuum pug mill is not performed among all steps according to an exemplary embodiment of the present invention, the product is weak and thus it cracks and can not be molded. In this case, it is impossible to adjust the moisture of the product, therefore the product is collapsed.

According to an exemplary embodiment of the present invention, however, any noxious substance such as the adhesive, etc., contained in the fly ash or the like is changed into the innoxious substances as it is mixed with the clay and calcinated.

Meanwhile, the product to be calcinated in the kiln contains some moisture. According to an exemplary embodiment of the present invention, the dried product is stacked and fired in the kiln while removing the moisture by gradually adjusting the temperature from 0° C. to 400° C.

When the temperature reaches 600° C., if no steam appears in a firepot and a chimney, the moisture is decided to be completely removed.

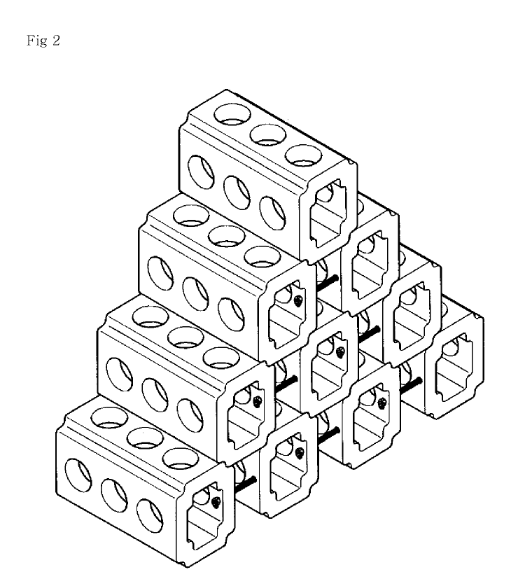

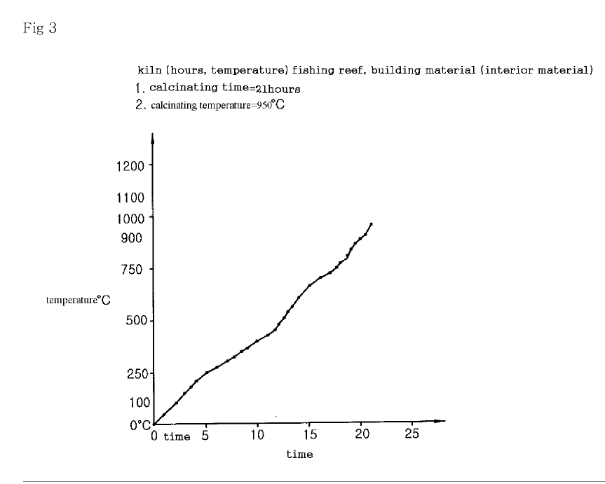

FIG. 2 illustrates a stacked state of fishing reefs as a marine construction formed by the manufacturing processes of FIG. 1, and FIG. 3 is a graph of temperature variation with respect to time for calcinating a fishing reef in a kiln.

As a result of inspecting the noxious components of the fishing reefs manufactured as shown in FIG. 2, noxious components such as lead, cadmium, chrome, copper, arsenic, mercury were not detected, so that the fishing reefs according to an exemplary embodiment of the present invention are very useful as an environmentally-friendly reef.

FIG. 2 illustrates the artificial reefs according to an exemplary embodiment of the present invention, but is not limited thereto. Alternatively, the present invention may be applied to a tile, a brick, a block, an interlocking, a curb, a hume pipe, a revetment block, a vegetation block or the like, for building and construction materials.

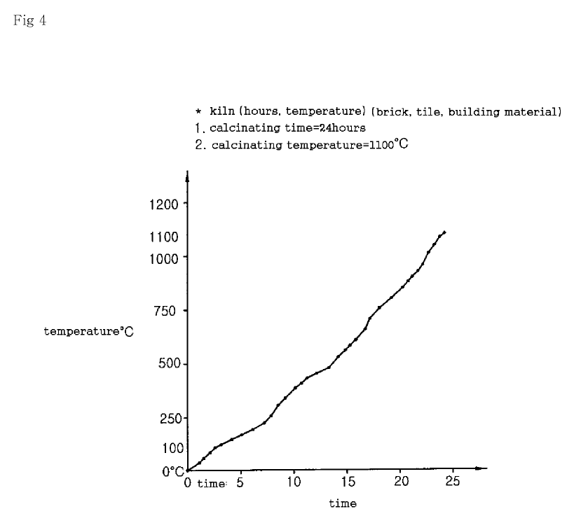

FIG. 4 is a graph of temperature variation with respect to time for calcinating a construction material such as a brick, a tile or the like in a kiln.

As shown in FIG. 4, the temperature adjustment determines the color of the brick, the tile or the like.

As described above, the present invention provides building and construction materials and a method of manufacturing the same, in which ash generated in a thermal power plant and buried is used as an alternative aggregate to a scantily available natural aggregate, thereby solving environmental problems due to burying wastes.

Further, the present invention provides building and construction materials and a method of manufacturing the same, which are environmentally-friendly and have long-term strength, so that they are advantageous in seashore facilities and more excellent in durability than a concrete using the existing aggregate.

Although the present invention has been described with reference to certain exemplary embodiments thereof, it will be understood by those skilled in the art that a variety of modifications and variations may be made to the present invention without departing from the spirit or scope of the present invention defined in the appended claims, and their equivalents.

1. A method of manufacturing building and construction materials, the method comprising:
creating a mixture by mixing clay ripened and aged in a supplier with ash and water;
removing foreign materials from the mixture using a selector;
removing air from the mixture using a vacuum pug mill;
molding the mixture by injecting the air-removed mixture into a prescribed mold and pressing the mixture with a press;
drying a product molded in the molding step; and
calcinating the dried product in a kiln.

2. The method as claimed in claim 1, wherein the calcination step is performed in a kiln heated at 1000˜1300° C. for 24˜30 hours.

3. The method as claimed in claim 2, wherein the drying step comprises a primary drying step for primarily removing moisture in shade for 1˜3 days, and a secondary drying step for secondarily removing moisture remaining after the primary drying step in sunlight.

4. The method as claimed in any one of claims 1 to 3, wherein the mixture is created by mixing the ripened and aged clay and the ash in a ratio of 50% to 40˜50%.

5. The method as claimed in claim 4, wherein the ash comprises fly ash or bottom ash.

6. The method as claimed in claim 1, wherein the clay is ripened and aged for one year.

7. The method as claimed in claim 2, wherein the calcination step further comprises adjusting colors of the building and construction materials through a cooling process.

8. The method as claimed in claim 1, further comprising checking whether the mixture contains air after removing the air.

9. Building material manufactured by a process comprising:
creating a mixture by mixing clay ripened and aged in a supplier with ash and water;
removing foreign materials from the mixture using a selector;
removing air from the mixture using a vacuum pug mill;
molding the mixture by injecting the air-removed mixture into a prescribed mold and pressing the mixture with a press;
drying a product molded in the molding step; and
calcinating the dried product in a kiln.

10. The material of claim 9, wherein the calcination step is performed in a kiln heated at 1000˜1300 for 24˜30 hours.

11. The material of claim 11, wherein the drying step comprises a primary drying step for primarily removing moisture in shade for 1˜3 days, and a secondary drying step for secondarily removing moisture remaining after the primary drying step in sunlight.

12. The material of claims 9, 10, or 11, wherein the mixture is created by mixing the ripened and aged clay and the ash in a ratio of 50% to 40˜50%.

13. The material of claim 12, wherein the ash comprises fly ash or bottom ash.

14. The material of claim 9, wherein the clay is ripened and aged for one year.

15. The material of claim 10, wherein the calcination step further comprises adjusting colors of the building and construction materials through a cooling process.

16. The material of claim 9, wherein the process further comprises checking whether the mixture contains air after removing the air.

17. The material of claim 9, wherein the material is one of a tile, a brick, a block, an interlocking, an artificial reef, a curb, a hume pipe, a revetment block and a vegetation block.
